(19) United States
(12) Patent Application Publication
(10) Pub. No.: US 2023/0413802 A1
(43) Pub. Date: Dec. 28, 2023

(54) Squib Disarming Bird Repellent Box

(71) Applicant: Repurpose Innovation LLC, Benton, AR (US)

(72) Inventor: Mark Z. Kelloms, Highlands Ranch, CO (US)

(73) Assignee: Repurpose Innovation LLC, (omitted)

(21) Appl. No.: 18/206,685

(22) Filed: Jun. 7, 2023

Related U.S. Application Data
(60) Provisional application No. 63/356,341, filed on Jun. 28, 2022.

(51) Int. Cl. A01M 29/20

(52) U.S. Cl. CPC A01M 29/20

(57) ABSTRACT

A combined apparatus for repelling birds from undesirable locations such as airports and critical adjacent airspace, while detonating used squibs for safety. A mobile, wheeled cabinet houses the components. An internal vise for temporarily securing squibs for preparation. Prepared squibs may be held internally of the cabinet with an internal multi-squib detonation fixture comprising a plurality of spaced apart mounting rings into which squibs may be coaxially received for firing. The mounting rings secure the squibs with peripheral wing nuts that are tightened to secure the squibs. A remote control circuit providing electrical power first illuminates a warning light in response to the actuation of an external, rotatable handle. The circuit is then remotely triggered for squib firing. In response to detonation, explosive gases are vented through discharge pipes, and considerable noise is directed outwardly towards a target area.

### CROSS REFERENCE TO RELATED APPLICATION

This utility patent application is based upon, and incorporates by reference, U.S. provisional patent application Ser. No. 63/356,341, filed Jun. 28, 2022, by inventor Mark Z. Kelloms, entitled “Squib Disarming Bird Repellent Box,” and priority based upon said previously filed pending provisional patent application is claimed is claimed.

### BACKGROUND OF THE INVENTION

### I. Field of the Invention

This invention relates generally to aviation safety, and more particularly to the elimination or repulsion of potentially dangerous birds or animals near airports and especially runways. Further, the invention relates to the disarming of aging, explosive squibs used in aviation and elsewhere that must be periodically replaced.

### II. Description of the Prior Art

It has long been recognized by those skilled in the art that the presence of wild birds or animals near or adjacent airports can present several dangers. Flocks of birds congregating and flying near or above runways may be sucked into jet engines with catastrophic results. The danger of collisions with birds and other flying animals presents a constant risk to aircraft. Modern safety considerations dictate that their presence proximate active runways and controlled airspace must be significantly reduced, if not eliminated. Primarily, these “bird strikes” occur during takeoff and landing of aircraft around airport runways and in the airspace above the runways. The majority of these bird strikes occur at less than 1,000 feet above the ground, with nearly three quarters of such strikes occurring at an altitude of 500 feet or less.

Thus birds should be deterred from occupying restricted airspace, such as the landing paths and runways of airports and their surrounding vicinity. A suitable deterrence system can trigger an animal's survival instinct, inducing fright and causing them to leave areas in which the system is used. All avian species will flee a perceived threat, and therefore, they can be conditioned to associate certain visual and audio stimuli with the presence of danger.

In addition to the safety hazard created by birds flying above and around airport runways, birds may also present a nuisance in agricultural areas to certain crops and to aquaculture farms, which may lose a significant percentage of their production to avian feeding. Unchecked animal or bird populations may cause considerable loss of crops and fruits in farms. Bird and animal droppings may create health-related problems and damage property, besides spreading disease.

The Federal Aviation Administration (i.e., FAA) has often comments on the issue and actively maintains programs to decrease bird collisions. Wildlife strikes, mainly from birds, cause severe damage to operating aircraft and in some cases lead to loss of life. In recent years due to increase in passenger traffic, the introduction of much quieter engines on newer planes and a large increase in wildlife population, the probability of wildlife strikes has increased dramatically. During the past century, wildlife-aircraft strikes have endangered numerous human lives worldwide. Billions of dollars in aircraft damage have resulted. The FAA maintains a comprehensive program to address wildlife hazards. See, for example, https://www.faa.gov/airports/airport_safety/wildlife/

According to the FAA, the management of wildlife on and near airports is not usually an easily solved problem. Bird management can be as diverse as habitat manipulation, the use of predators for repelling wildlife, and the lethal termination of unwanted wildlife. Wildlife associated with safety issues at airports includes birds, mammals and reptiles. Birds' make-up 97% of the reported strikes, mammals about 3%, and reptiles less than 1%. The large number of bird strikes has resulted in a major effort by United States and Canadian airport officials to find ways to handle this problem, including the establishment of a Bird Strike Committee. Mammals are the most common animals other than birds which are associated with aircraft strikes. Mammal strikes are only a small percent of the total recorded strikes, but strikes with large ungulates including deer are extremely dangerous. The number of white-tailed deer in the US has increased from 100,000 in 1900 to 30 million in 2019. From 1990 to 2019, 1,210 civil aircraft were involved with numerous deer hits. Several prior art attempts at driving off birds or other animal from sensitive areas exist. For example, U.S. Pat. No. 2,920,600 issued to Katsu on Jan. 12, 1960 discloses an “Intermittent Exploding Device” for farmers, designed to periodically rid fields and crops from hungry birds or animals.

U.S. Pat. No. 3,412,394 discloses a photocell-controlled mechanism for driving off pests such as birds.

U.S. Pat. No. 3,897,195 issued to Finch on Jul. 29, 1975 and provides a noise making apparatus for protecting crops from wildlife. The device comprises a combustion chamber supplied with explosive gases by a feeding mechanism. A sparking device in the combustion chamber explodes the gases. A spark control device ignites the sparking device when the pressure of gas in the combustion chamber reaches a predetermined level.

U. S. Publication 20100230531 to Fayed et al., published Sep. 16, 2010, discloses methods for deterring birds from flying above airport runways. The system features at least one mortar for firing a pyrotechnic device to produce a light and sound display for the purpose of disturbing, frightening, and harassing birds so as to deter them from flying into airspace above and in the vicinity of an airport runway. The mortars of the system can be installed on a mounting platform capable of being securely connected to the ground or a ground surface substrate or to a vehicle. Light and sound display produced by exploding pyrotechnics can be varied to prevent the birds from becoming desensitized to the sounds and visual effects of the system.

U. S. Publication 20180213768 to Holt published Aug. 2, 2018 discloses a portable bird scaring device using the random movement of a sock. A marine fan, activated by a waterproof switch, and powered by a deep-cycle battery can create sufficient movement to startle and drive off birds.

U. S. Publication 20190387734 to Sullivan issued Dec. 26, 2019 discloses a detonator that fire blank cartridges. The detonator may be detachably coupled to a drone, and the device may be fired during drone flight. The actuator may be in communication with a remote control source. A method of animal and bird control using the drone detonator may include attaching the detonator to a drone, flying the drone to a target zone, and detonating the blank cartridge at the target zone.

With the foregoing in mind, one potential noise source for bird repellent systems is provided by retired explosive “squibs.” A squib is a miniature explosive device used in a wide range of industries, from special effects to military applications. Squibs are also known as “explosive cartridges,” and they may be electrically detonated. Periodically they must be changed during regular maintenance since they have a known useful life. They resemble a tiny stick of dynamite, both in appearance and construction, but exhibit considerably less explosive power. If not detonated after the squib useful life expires, then they are especially difficult to dispose of, since live squibs are classified as hazardous waste. Thus the detonation or deactivation of old squibs before disposal is desirable.

Squibs typically comprise electrical leads separated by a plug of insulating material, a small bridge wire or electrical resistance heater, and a bead of heat-sensitive chemical composition, in which the bridge wire is embedded. They can be used to generate mechanical force to shatter or propel various materials, such as fire-retardants used in aviation to extinguish engine fires. Such squibs must be periodically changed during routine aviation maintenance, and the replaced squibs, which are classified as hazardous waste, are especially difficult to dispose of properly. To mitigate that fact, they must be detonated or disarmed before subsequent safe disposal. The latter fact suggests their use in explosive noise-makers, such as bird repellent devices.

### SUMMARY OF THE INVENTION

This invention provides a combined apparatus and methods for controlling animal presence, particularly birds, to eliminate them from unwanted areas such as airports and critical adjacent airspace. The invention may employ expired, explosive squibs and other explosive devices of the type used in aviation to detonate fire retardant vessels for extinguishing engine fires. Such squibs, also known as “explosive cartridges,” must be periodically removed and replaced during aircraft, rocket or other forms of technical maintenance. The invention disarms expired squibs by firing them within a controlled environment, and the resultant explosive noises are directed out of the apparatus for repelling animals and birds.

Thus a basic object of the invention is to remove birds from airport runways and adjacent airport airspace to decreases the chances of destructive avian collisions.

Another basic object is to deter birds and other animals from entering into or occupying critical areas around or proximate airports, farms, and other areas.

Thus a primary object is to increase aviation safety.

A related object is to repel birds and wild animals from critical airspace in and around airports.

An ancillary object is to drive off unwanted animals and birds from farm fields and the like.

Another basic object is to reduce airplane bird strikes at airports.

Yet another object is to drive off birds and wild animals from undesired locations without the use of chemicals, pesticides, or poisons.

All of the foregoing goals and objects notwithstanding, it is also a primary object of the invention to provide a safe and economically satisfactory apparatus and method for disarming explosive squibs that are removed during routine aircraft maintenance.

Another basic object is to safely disarm expired squibs, particularly expired DOT 1.4S squibs.

It is also an object to reduce costs associated with noise-producing animal deterrent systems. It is a feature of this invention that expired squibs, that must be regularly replaced and discarded, are used for noise production to enhance airport safety at a minimal cost.

These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is an isometric view of my new invention, comprising a Combined Squib Disarming and Bird Repellent Box;

FIG. 2 is an isometric view thereof, with the lid opened;

FIG. 3 is a top plan view thereof;

FIG. 4 is an upper fragmentary isometric view showing the cabinet interior, locking structure and the preferred battery housing;

FIG. 5 is a fragmentary plan view of the squib detonation compartment;

FIG. 6 is a pictorial view showing a conventional, disassembled squib that can be safely detonated with the instant invention;

FIG. 7 is a fragmentary isometric view of a preferred squib retention fixture;

FIG. 8 is a sectional view taken generally along line 8-8 in FIG. 5; and,

FIG. 9 is an electrical schematic diagram of the preferred control circuit.

### DETAILED DESCRIPTION OF THE DRAWINGS

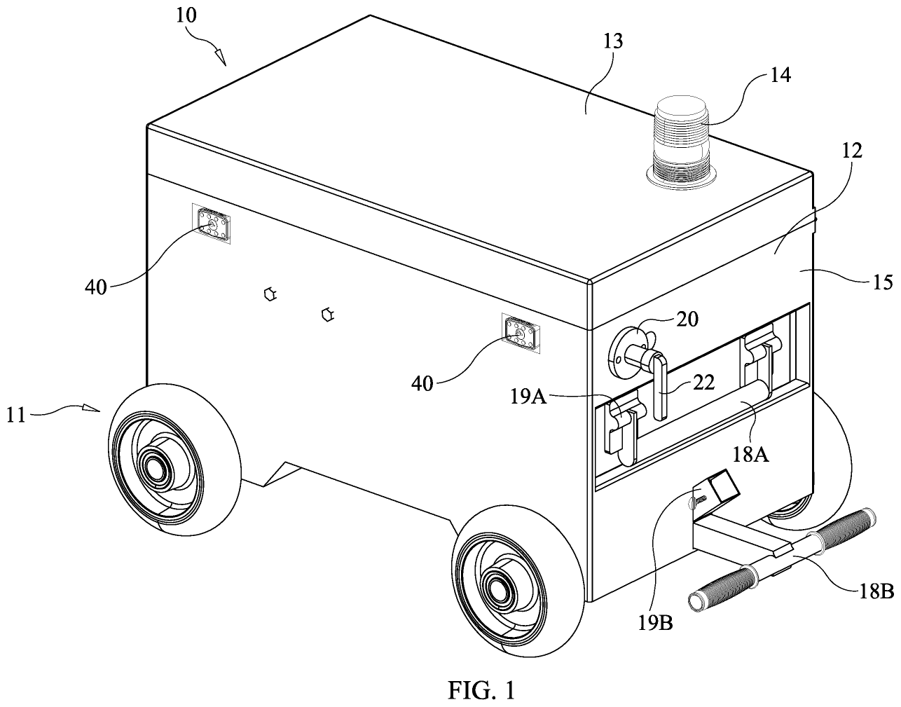

Turning initially now to FIGS. 1-3 2 of the appended drawings, my new “Combined Squib Disposal and Bird Repellent Box” has been generally designated by the reference numeral 10. The invention comprises a preferably metallic, rigid cabinet 12 that is generally in the form of a parallelepiped. Cabinet 12 comprises a pair of spaced-apart and generally parallel end panels, one of which is seen in FIG. 1 and designated with the reference numeral 15. Cabinet 12 comprises a displaceable cover 13 upon which a bright, electrically powered warning light fixture 14 flashes during use and prior to firing for unmistakably indicating the firing state of the invention. The cabinet 12 is preferably supported upon a plurality of transport wheels 11 for locomotion.

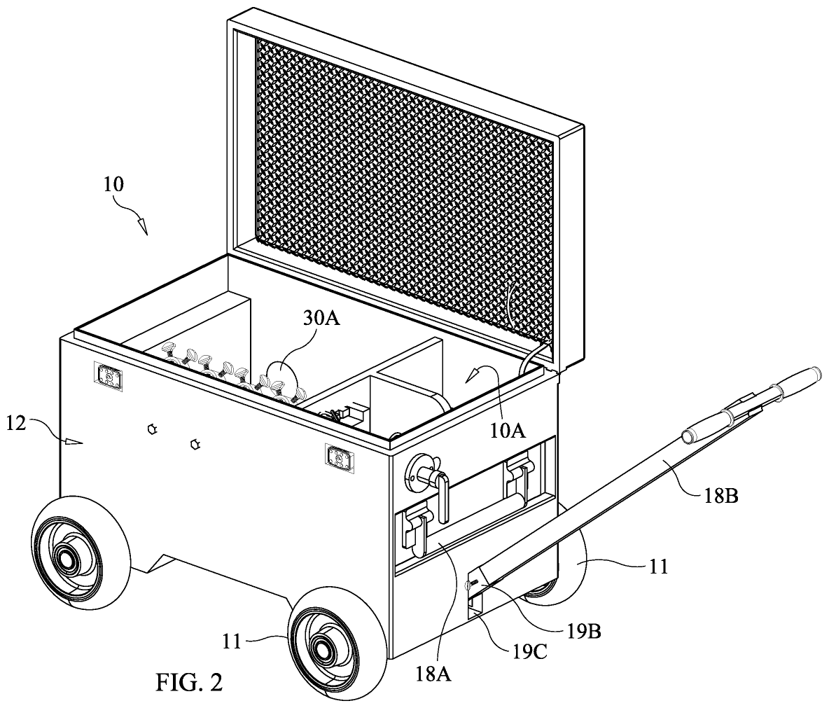

Each cabinet end panel such as panel 15 supports a convenient, pivotal handle 18A supported by hinges 19A for aiding in the maneuvering and relatively small displacements of the device. In addition there is a larger handle 18B that may be removably coupled to receiver 19B forming an approximately forty-five degree angle as in FIG. 2, or which may be telescopically received within a lower passageway 19C (FIG. 2) to orient it flatly in an out-of-the way position that is generally parallel with the ground.

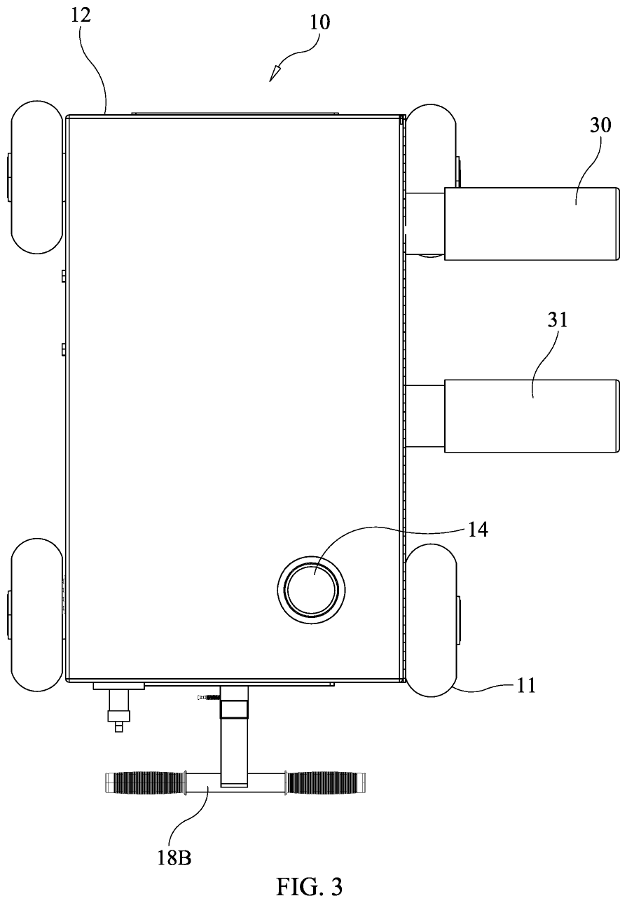

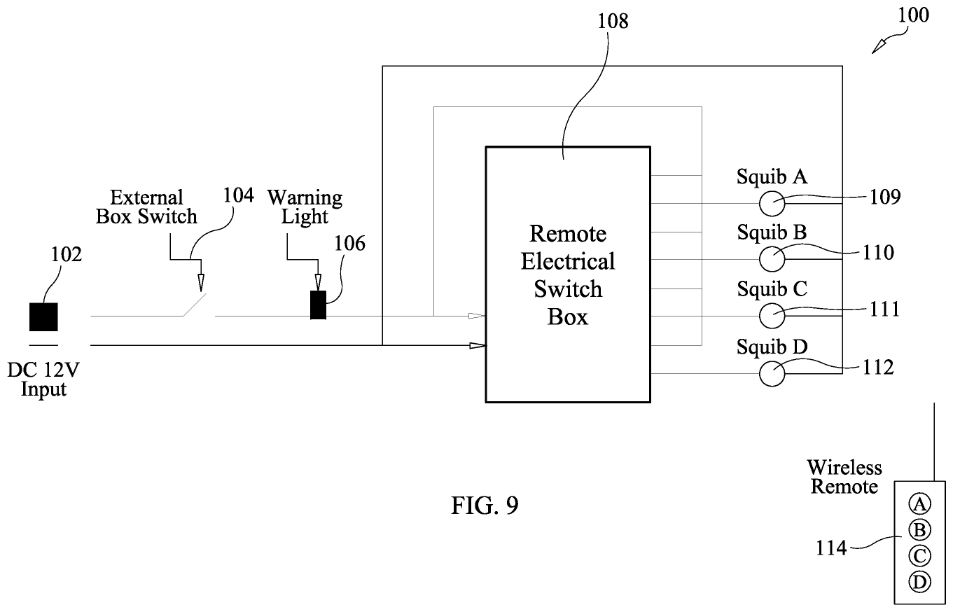

Panel 15 also supports an electrical “on-off” switch 20 that is mechanically actuated by a rotatable handle 22 for placing the device 10 in a ready state. A typical key-operated switch may be used for switch 20. Switch 20 and light fixture 14 are connected to wiring disposed within the cabinet 12 as seen in FIG. 9 and explained below. Visible in FIG. 3 are a pair of parallel and spaced apart blast discharge tubes 30 and 31 explained hereinafter that are disposed on the opposite side of the cabinet 12. Tube 30 is secured to a discharge orifice 30A seen in FIG. 2). Tubes 30 and 31 connect the cabinet interior in fluid flow communication with the outside.

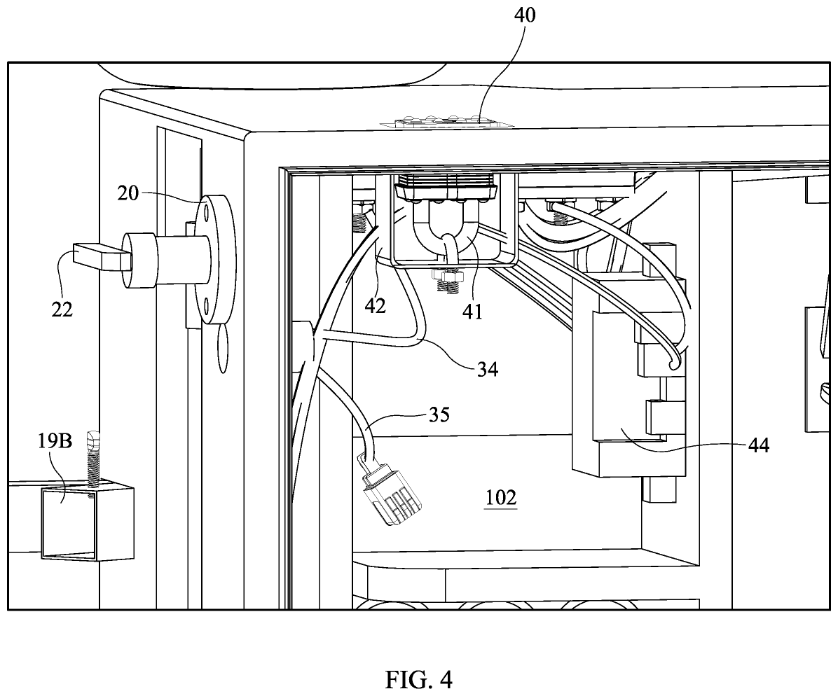

The cabinet 12 encloses a generously sized, somewhat cubical interior 10A in which wiring and various components are mounted. The switch 20 closes or opens a pair of power lines 34 and 35 respectively (FIG. 4) ultimately energized by a battery within battery housing 102 (FIGS. 4, 9) through a remote electrical switch box 44. Power supplied by the battery system and activated by switch 20 via its control circuitry will be directed through the switch box 44, activating the warning light fixture 14 and preparing for firing.

A locking system is provided. In FIG. 1, the rear ends of a pair of spaced-apart, conventional padlocks 40 are seen. These key-operated padlocks are nested through suitable orifices within the cabinet, and their shackles 41 enter the cabinet interior, as illustrated in FIG. 4, and engage a locking bracket 42.

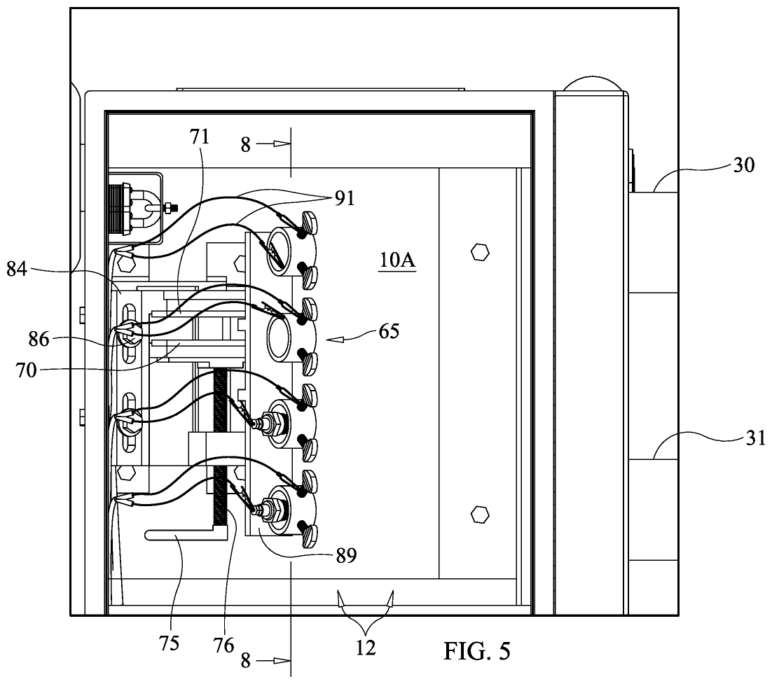

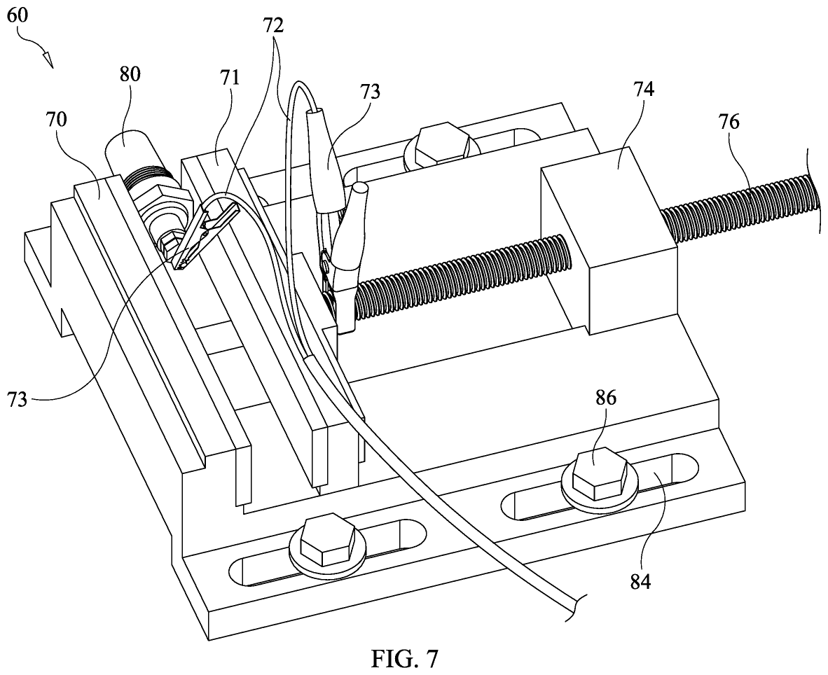

Referring mainly to FIG. 7, the cabinet interior 10A houses a squib vise 60 that comprises a pair of compressible jaws 70 and 71 that are activated by a rotatable vise handle 75 (FIG. 5) that rotatably displaces threaded rod 76 that is threadably directed through block 74. When the jaws 70, 71 are suitably compressed, a live single squib 80 may be temporarily captivated by the vise 60 for forcibly removing certain packaging and parts from the active element. Activation wires 72 that may terminate in alligator clips 73 for attachment to squib terminals to fire the retained squib 80. The frame of vise 60 is adjustably, slidably mounted by fasteners 86 that track within follower slots 84, engaging a header (not seen) within cabinet 12. Vise 60 is disposed adjacent a rigid, multiple squib detonation fixture 65.

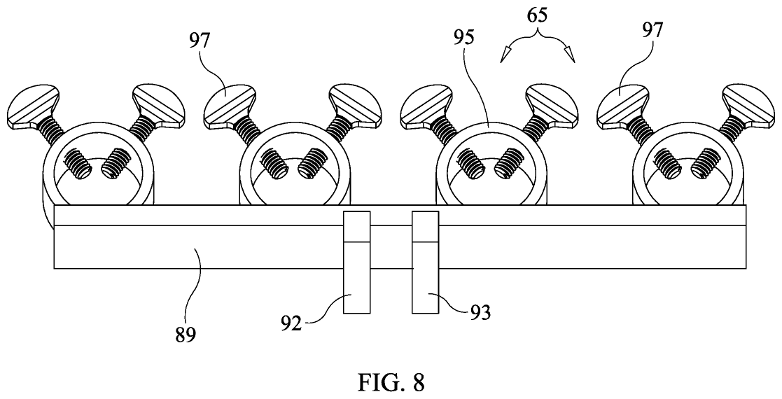

The multi-squib detonation fixture 65 (FIG. 8) is used to controllably fire and disarm multiple squibs of average size. The multi-squib detonation fixture 65 may be removed if a squib is of an abnormal size (larger), and the larger squib may be directly held with the vise 60 (FIG. 7). The metal squibs will be loaded and ultimately fired as is typical in aviation.

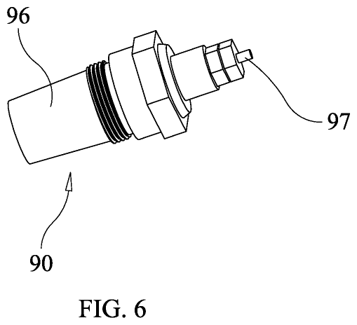

Referencing FIG. 6, a typical squib assembly 90 comprises a substantially tubular, body with an explosive region 96 bounded by an outwardly projecting electric terminal 97. Suitable wiring connected to terminal 97 can fire the squib.

With primary reference now directed jointly to FIGS. 5 and 8, the squib detonation fixture 65 comprises an elongated, rigid frame 89 adapted to be secured for use by a pair of spaced apart flanges 92 and 93 (FIG. 8). The fixture's flanges 92 and 93 are oriented forty-five degrees relative to the floor of the cabinet. Frame 89 (FIG. 8) mounts a plurality of spaced apart mounting rings 95, each of which has a pair of radially spaced apart wing nuts 97 projecting from its periphery. Squibs to be fired are retained until discharged within the rings 95, being frictionally secured by appropriate tightening of the wing nuts 97. The vise is designed to either hold a single large squib or be able to hold multiple squibs as in FIG. 8. When firing occurs, explosive gases are discharged through pipes 30 and 31 (FIG. 3), causing considerable noise. Wires 91 fire the squibs.

Referencing FIG. 9, the circuit for operation and control has been generally designated by the reference numeral 100. Twelve-volt DC. power is applied from battery 102 through an SPST switch 104 driven by handle 22. When switch 104 closes, incandescent bulbs or LED's 106 disposed within light fixture 14 (FIG. 1) illuminate. Electrical switch box 108 energizes one or more squibs, designated 109, 110, 111, and 112. Switch box 108 is remotely controlled by wireless remote 114.

From the foregoing, it will be seen that this invention is one well adapted to obtain all the ends and objects herein set forth, together with other advantages which are inherent to the structure.

Further, it will be understood that certain features and subcombinations are of utility and may be employed without reference to other features and sub combinations.

As many possible embodiments may be made of the invention without departing from the scope thereof, it is to be understood that all matter herein set forth or shown in the accompanying drawings is to be interpreted as illustrative and not in a limiting sense.

What is claimed is:

1. A device for concurrently repelling animals while detonating used squibs, the device comprising:
a rigid, wheeled for enclosing and transporting components of the device, the cabinet comprising an interior;
an electrical circuit for powering the device and controlling squib detonation;
at least one blast discharge tube for venting the cabinet interior and outputting noise in response to squib firing;
an externally actuated “on-off” switch mechanically actuated by a handle projecting exteriorly of the cabinet for powering the circuit;
a multi-squib detonation fixture for holding multiple squibs for firing; and,
an actuator for instructing the circuit to fire one or more squibs.

2. The device as recited in claim 1 wherein the squib detonation fixture comprises a plurality of spaced apart mounting rings for receiving and mounting squibs to be fired.

3. The device as recited in claim 2 wherein said rings comprises at least one wing nut for tightly securing squibs.

4. The device as recited in claim 1 wherein the cabinet comprises at least one adjustable and external handle for cabinet locomotion.

5. The device as recited in claim 1 further comprising a squib vise with a pair of compressible jaws for temporarily captivating live squibs to be prepared for subsequent firing.

6. The device as recited in claim 5 further comprising clips for attachment to terminals of squibs held within said vise sparks for shorting them to prevent inadvertent firing.

7. The device as recited in claim 1 wherein the device comprises a warning light that is activated by said circuit prior to squib firing.
